(19) United States
(12) Patent Application Publication
(10) Pub. No.: US 2026/0276816 A1
(43) Pub. Date: Sep. 17, 2026

(54) LIDAR AND CARRIER

(71) Applicant: HESAI TECHNOLOGY CO., LTD., Shanghai (CN)

(72) Inventors: Ji WANG, Shanghai (CN); Jun TAO, Shanghai (CN); Shaoqing XIANG, Shanghai (CN)

(73) Assignee: HESAI TECHNOLOGY CO., LTD., Shanghai (CN)

(21) Appl. No.: 19/678,820

(22) Filed: May 15, 2026

Related U.S. Application Data
(63) Continuation of application No. PCT/CN2024/132591, filed on Nov. 18, 2024.

(30) Foreign Application Priority Data
Nov. 17, 2023 (CN) 202311545717.X
Nov. 17, 2023 (CN) 202323128741.1

(51) Int. Cl. G01S 17/08; G01S 7/48; G01S 7/481; G01S 7/4863; G01S 7/499; G02B 26/10; H04N 25/773

(52) U.S. Cl. CPC G01S 17/08; G01S 7/4802; G01S 7/4813; G01S 7/4863; G01S 7/499; G02B 26/10; H04N 25/773

(57) ABSTRACT

This disclosure provides a LiDAR, including: an optical transceiver module and a scanner module, where the optical transceiver module includes: an transmitter unit; a transmitting lens unit, configured to transmit detection light; a receiver lens unit, separated from the transmitting lens unit, and configured to transmit echo light generated by reflection of the detection light from an object. In a LiDAR with the scanner module of this disclosure, using the two-dimensional array detector can reduce a receiving field of view corresponding to each detector in the LiDAR, which is conducive to improving an optical resolution of an optical system of the LiDAR. Moreover, the separately provided transmitting lens unit and receiving lens unit help improve aberrations of the transmitting lens unit and the receiving lens unit, facilitate mass production, and can also reduce area requirements for the two-dimensional array detector.

### CROSS-REFERENCE TO RELATED APPLICATIONS(S)

This application is a continuation application of copending International Patent Application No. PCT/CN2024/132591, filed Nov. 18, 2024, which claims priority to Chinese Patent Application No. 202311545717.X, filed Nov. 17, 2023, and Chinese Patent Application No. 202323128741.1, filed Nov. 17, 2023, the content of which is incorporated herein by reference in its entirety.

### TECHNICAL FIELD

This disclosure relates to the field of LiDAR and, in particular, to a LiDAR.

### BACKGROUND

A LIDAR (“Light Detection and Ranging”) is a widely used ranging sensor characterized by long detection range, high resolution, and robustness to to environmental interference, and is widely used in unmanned driving, intelligent robots, unmanned aerial vehicles, and other fields. In recent years, autonomous driving technologies have developed rapidly, and the LiDAR, as a core sensor for distance perception, is indispensable.

In the LiDAR, a light beam is reflected by a reflecting surface of a scanner module, thereby forming a scanning light beam for spatial scanning. The scanner module for the LiDAR realizes scanning of the scanning light beam within a field of the LiDAR through reciprocating motion of the reflecting surface.

However, in an existing LiDAR, a receiving field of view corresponding to each detector is relatively large, resulting in a weak target resolution capability of the LiDAR. On the other hand, methods of reducing the receiving field of view and improving the target resolution capability tend to cause deterioration of aberrations in an optical system of the LiDAR, and also lead to problems of difficulty in manufacturing and high production costs.

### SUMMARY

A problem addressed by this disclosure is how to reduce aberrations, simplify manufacturing, and lower production costs while enhancing a target resolution capability of a LiDAR.

To solve the above problem, this disclosure provides a LiDAR, including: an optical transceiver module and a scanner module, where the optical transceiver module includes: a transmitter unit where the transmitter unit is configured to emit detection light; a transmitting lens unit, where the transmitting lens unit is configured to transmit the detection light; a receiving lens unit, where the receiving lens unit is separated from the transmitting lens unit, and the receiving lens unit is configured to transmit echo light generated by reflection of the detection light from an object; and a receiver unit, where the receiver unit includes: a two-dimensional array detector, where the two-dimensional array detector is configured to detect the echo light passing through the receiving lens unit; and the scanner module is configured to receive the detection light and emit the detection light towards an exterior of the LiDAR, and receive the echo light and emit the echo light towards the optical transceiver module.

Optionally, the transmitting lens unit includes a reflector and a transmitting lens, where the transmitting lens includes at least one transmitting lens element, and the reflector is configured to reflect the detection light to the scanner module.

Optionally, the receiving lens unit includes a receiving lens, where the receiving lens includes at least one receiving lens element.

Optionally, a focal length of the receiving lens is determined based on a spacing between adjacent pixels in the two-dimensional array detector and an angular resolution of the LiDAR.

Optionally, the focal length of the receiving lens is not greater than a focal length of the transmitting lens of the transmitting lens unit.

Optionally, a receiving assembly is located between a transmitting assembly and the scanner module, where the transmitting assembly includes: the transmitter unit and the transmitting lens unit, and the receiving assembly includes: the receiver unit and the receiving lens unit.

Optionally, a size of a pixel in the two-dimensional array detector is greater than an optical parameter of the receiving lens.

Optionally, a receiving aperture of the receiving lens is greater than 8 mm.

Optionally, an F-number of the receiving lens is less than 4.

Optionally, a laser of the transmitter unit and a two-dimensional array detector of the receiver unit are provided on a same circuit board.

Optionally, the optical transceiver module further includes a support member, where at least the transmitting lens unit is fixed to the support member.

Optionally, the transmitting lens unit and a beam splitter unit are fixed to the support member.

Optionally, the optical transceiver module further includes a receiving lens support member, where the receiving lens is fixed to the receiving lens support member, and the receiving lens support member is movably connected to the support member.

Optionally, a circuit board fixing the two-dimensional array detector has multiple focusing marks.

Optionally, the receiving lens unit, the transmitting lens unit, and the beam splitter unit are fixed to the support member.

Optionally, the receiver unit includes one two-dimensional array detector, where the two-dimensional array detector includes multiple detection regions, and the multiple detection regions are in one-to-one correspondence with multiple lasers of the transmitter unit.

Optionally, the two-dimensional array detector further includes a compensation region, where the compensation region encircles the multiple detection regions.

Optionally, the receiver unit includes multiple two-dimensional array detectors, where the multiple two-dimensional array detectors are in one-to-one correspondence with of the multiple lasers of the transmitter unit.

Optionally, the multiple two-dimensional array detectors are arranged in an array, and the two-dimensional array detectors in adjacent columns are provided in a staggered manner along a column direction or two-dimensional array detectors in adjacent rows are provided in a staggered manner along a row direction.

Optionally, the two-dimensional array detector includes multiple pixels, where each of the pixels includes multiple detection elements.

Optionally, a detection element is a single-photon detection element.

Optionally, the optical transceiver module further includes a beam splitter unit, where the beam splitter unit is configured to transmit the detection light transmitted by the transmitting lens unit to the scanner module, and is configured to transmit the echo light transmitted by the scanner module to the receiving lens unit.

Optionally, the beam splitter unit includes a polarization beam splitter element and a wave plate, where the wave plate is located in an optical path between the polarization beam splitter element and the scanner module.

Optionally, the wave plate is attached to a surface of the polarization beam splitter element facing the scanner module.

Optionally, the scanner module includes a polygonal mirror, where the polygonal mirror includes multiple reflecting surfaces, the multiple reflecting surfaces rotate around a rotating shaft, and angles between different reflecting surfaces and the rotating shaft are partially the same.

Optionally, the polygonal mirror has an even number of reflecting surfaces, where angles between adjacent reflecting surfaces and the rotating shaft are different, while angles between spaced-apart reflecting surfaces and the rotating shaft are the same.

Compared with the prior art, technical solutions of this disclosure have the following advantages.

In the technical solutions of this disclosure, in the receiver unit, using the two-dimensional array detector to receive the echo light can effectively reduce a receiving field of view corresponding to a detector in the LiDAR, which is conducive to improving an optical resolution of an optical system of the LiDAR and improving a target resolution capability of the LiDAR. With respect to the two-dimensional array detector, in the optical transceiver module, the separated transmitting lens unit and receiving lens unit are used to transmit the detection light and the echo light, respectively, different lens units are used to transmit the detection light and the echo light, respectively, and the detection light and the echo light are not transmitted through the same lens unit, which is conducive to reducing the aberrations of the transmitting lens unit and the receiving lens unit, facilitating the mass production, further effectively reducing area requirements on the two-dimensional array detector, and lowering the costs.

In an optional solution of this disclosure, the focal length of the receiving lens is not greater than the focal length of the transmitting lens of the transmitting lens unit. A transmitting lens with a larger focal length is adapted to a laser with a larger light-emitting area, and a receiving lens with a smaller focal length is adapted to a detector with a smaller photosensitive area. The transmitting lens with the larger focal length and the receiving lens with the smaller focal length are adapted to the laser with the larger light-emitting area and the detector with the smaller photosensitive area, while a transmission field and a reception field match, which is conducive to improving a long-range detection capability of the LiDAR.

In an optional solution of this disclosure, the size of the pixel in the two-dimensional array detector is greater than the optical parameter of the receiving lens. The optical parameter of the receiving lens can be a root-mean-square spot radius of the receiving lens. A relationship between the size of the pixel in the two-dimensional array detector and the optical parameter of the receiving lens will affect point cloud quality and optical resolution received by the two-dimensional array detector. The size of the pixel in the two-dimensional array detector matches the optical parameter of the receiving lens, which is conducive to improving the optical resolution of the LiDAR, acquiring best imaging quality, and improving the point cloud quality of the LiDAR.

In an optional solution of this disclosure, the receiving aperture of the receiving lens is greater than 8 mm. The larger the receiving aperture of the receiving lens, the higher the receiving efficiency of the LiDAR for the echo light, and the stronger the long-range detection capability of the LiDAR. A sufficiently large receiving aperture of the receiving lens is conducive to improving the receiving efficiency of the echo light and enhancing the long-range detection capability of the LiDAR.

In an optional solution of this disclosure, the F-number of the receiving lens is less than 4. The F-number of a lens, for example, an aperture ratio of the lens, is a ratio of a focal length of the lens to a diameter of an entrance pupil thereof. Luminous flux of the lens is inversely proportional to a square of the F-number. The smaller the F-number, the greater the luminous flux. The smaller the F-number of the receiving lens, the larger the receiving aperture of the receiving lens, and the higher the receiving efficiency of the echo light. A sufficiently small F-number of the receiving lens is conducive to improving the receiving efficiency of the echo light.

In an optional solution of this disclosure, the laser of the transmitter unit and the two-dimensional array detector of the receiver unit are provided on a same circuit board. The laser of the transmitter unit and the two-dimensional array detector of the receiver unit are integrated on a common board, which is conducive to the mass production of the LiDAR.

In an optional solution of this disclosure, the two-dimensional array detector further includes the compensation region, where the compensation region encircles the multiple detection regions. The two-dimensional array detector can be driven in an addressable manner. The two-dimensional array detector achieves alignment of the transmission field and the reception field through addressable driving, and compensates for alignment errors between the transmission field and the reception field using the compensation region, thereby reducing difficulty in optical alignment and adjustment, and even avoiding an optical alignment and adjustment process. This is conducive to adjustment-free alignment of a laser and a detector integrated on the common board.

In an optional solution of this disclosure, the beam splitter unit includes the polarization beam splitter element and the wave plate, where the wave plate is located in the optical path between the polarization beam splitter element and the scanner module. A solution that uses a polarization for beam splitting is conducive to effectively improving transmission efficiency under volume constraints of the LiDAR, and is conducive to improving performance of the LiDAR.

In an optional solution of this disclosure, the wave plate is attached to the surface of the polarization beam splitter element facing the scanner module. The wave plate is directly attached to the surface of the polarization beam splitter element, and neither the wave plate nor a bonded surface between the wave plate and the polarization beam splitter element needs an anti-reflection coating, which is conducive to effectively reducing coating costs. Moreover, the wave plate and the polarization beam splitter element are fixedly connected, which is conducive to reducing the number of positioning surfaces, thereby lowering mechanical design complexity and costs. In addition, the wave plate and the polarization beam splitter element are fixedly connected, which is also conducive to reducing the number of assembly elements and lowering the production costs. Furthermore, the polarization beam splitter element is of a flat plate structure, and compared with a polarization beam splitter element of a prism structure, costs are lower, which is conducive to further lowering the costs of the LiDAR.

In an optional solution of this disclosure, the scanner module includes the polygonal mirror, where the polygonal mirror includes the multiple reflecting surfaces, the multiple reflecting surfaces rotate around the rotating shaft, and the angles between different reflecting surfaces and the rotating shaft are partially the same. The angles between different reflecting surfaces and the rotating shaft are partially the same, thereby achieving adjustment of different field directions, which expands a vertical field range of the LiDAR without increasing design difficulty in the lens and increasing the aperture of the lens, such that the costs are lowered. Furthermore, it is further conducive to reducing a size of the circuit board provided with the laser and the two-dimensional array detector, which is conducive to effectively lowering a height of the LiDAR.

### BRIEF DESCRIPTION OF THE DRAWINGS

To illustrate technical solutions of embodiments of this disclosure or in the prior art more clearly, a brief introduction to accompanying drawings that are needed to be used in description of the embodiments or the prior art is given below. Obviously, the accompanying drawings depicted below are merely the embodiments of this disclosure, and those ordinary skilled in the art can obtain other accompanying drawings based on the provided accompanying drawings without creative effort. The accompanying drawings are used to provide further understanding of this disclosure, and form a part of this disclosure, and together with the embodiments of this disclosure, serve to explain this disclosure and do not constitute limitations on this disclosure. In the drawings:

FIG. 1 shows a functional block diagram of a LiDAR, provided in some embodiments of this disclosure.

FIG. 2 shows a schematic structural diagram of a transmitter unit of the LiDAR shown in FIG. 1, provided in some embodiments of this disclosure.

FIG. 3 shows a schematic structural diagram of an optical path of the LiDAR shown in FIG. 1, provided in some embodiments of this disclosure.

FIG. 4 shows a schematic diagram of a field of the LiDAR shown in FIG. 1, provided in some embodiments of this disclosure.

FIG. 5 shows a functional block diagram of a LiDAR, provided in some other embodiments of this disclosure.

FIG. 6 shows a schematic structural diagram of an optical path of the LiDAR shown in FIG. 5, provided in some other embodiments of this disclosure.

FIG. 7 shows a schematic structural diagram of a transmitter unit of the LiDAR shown in FIG. 5, provided in another embodiment of this disclosure.

### DETAILED DESCRIPTION

In the following, merely some exemplary embodiments are briefly described. As can be appreciated by those skilled in the art, embodiments described can be modified in various ways without departing from spirit or a scope of this disclosure. Accompanying drawings and description are to be regarded as illustrative in nature and not restrictive.

In the description of this disclosure, it should be understood that an orientation or positional relationship indicated by terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise” is based on an orientation or positional relationship shown in the accompanying drawings, and is merely for convenience of describing this disclosure and simplifying the description, rather than indicate or imply that equipment or an element referred to must have a specific orientation, be configured and operated in a specific orientation, and therefore cannot be understood as a limitation on this disclosure. In addition, terms “first” and “second” are merely for a descriptive purpose and cannot be understood as indicating or implying relative importance, or implicitly indicating the number of indicated technical features. Therefore, features defined with “first” and “second” can explicitly or implicitly include one or more features. In the description of this disclosure, a word “multiple” means two or more, unless expressly defined otherwise.

In the description of this disclosure, in some embodiments, unless otherwise expressly specified and defined, terms “mounted,” “connected,” and “coupled” shall be construed broadly. For example, it can be a fixed connection, a detachable connection, or an integral connection; it can be a mechanical connection, an electrical connection, or can be communicated with each other; and it can be a direct connection, or an indirect connection via an intermediate medium, or it can be an internal communication between two elements or an interaction relationship between two elements. For those ordinary skilled in the art, specific meanings of the above terms in this disclosure can be understood based on actual circumstances.

In this disclosure, unless otherwise specified and limited, a first feature being located “above” or “below” a second feature can involve direct contact between the first feature and second feature, or can involve that the first feature and second feature are not in direct contact with each other but in contact through additional features between them. Moreover, the first feature being located “over,” “above,” or “on” the second feature can involve that the first feature is directly above and obliquely above the second feature, or merely represent that a horizontal height of the first feature is higher than a horizontal height of the second feature. The first feature being located “under,” “below,” or “beneath” the second feature can involve that the first feature is directly below and obliquely below the second feature, or merely represent that a horizontal height of the first feature is lower than a horizontal height of the second feature.

The following disclosure provides many different embodiments or examples for implementing different structures of this disclosure. To simplify a disclosure of this disclosure, components and arrangements of specific examples are described below. Of course, they are merely examples and are not intended to limit this disclosure. In addition, at least one of reference numerals or reference letters can be repeated in different examples in this disclosure, and this repetition is for a purpose of simplicity and clarity, and does not in itself represent a relationship between at least one of various implementation manners or arrangements discussed. In addition, this disclosure provides examples of various specific processes and materials, but those ordinary skilled in the art can recognize at least one of application of other processes or use of other materials.

It can be seen from BACKGROUND that a LiDAR in the prior art has difficulty in balancing issues of reducing a receiving field of view, improving a target resolution capability of the LiDAR, reducing aberrations of an optical system, reducing manufacturing difficulty, and lowering production costs.

To solve the above problem, this disclosure provides a LiDAR, including: an optical transceiver module and a scanner module.

The optical transceiver module includes: a transmitter unit, where the transmitter unit is configured to emit detection light; a transmitting lens unit, where the transmitting lens unit is configured to transmit the detection light; a receiving lens unit, where the receiving lens unit is separated from the transmitting lens unit, and the receiving lens unit is configured to transmit echo light generated by reflection of the detection light from an object; and a receiver unit, where the receiver unit includes: a two-dimensional array detector, where the two-dimensional array detector is configured to detect the echo light passing through the receiving lens unit. The scanner module is configured to receive the detection light and emit the detection light towards an exterior of the LiDAR, and receive the echo light and emit the echo light towards the optical transceiver module.

In technical solutions of this disclosure, in the receiver unit, using the two-dimensional array detector to receive the echo light is conducive to effectively reducing a receiving field of view corresponding to a detector in the LiDAR, improving an optical resolution of an optical system of the LiDAR, and improving a target resolution capability of the LiDAR. With respect to the two-dimensional array detector, in the optical transceiver module, the separated transmitting lens unit and receiving lens unit are used to transmit the detection light and the echo light, respectively, different lens units are used to transmit the detection light and the echo light, respectively, and the detection light and the echo light are not transmitted through the same lens unit, which is conducive to effectively reducing aberrations of the transmitting lens unit and the receiving lens unit, facilitating mass production, further effectively reducing area requirements on the two-dimensional array detector, and lowering costs.

To make the above objectives, features and advantages of this disclosure more obvious and readily understood, specific embodiments of this disclosure are described below in detail with reference to accompanying drawings.

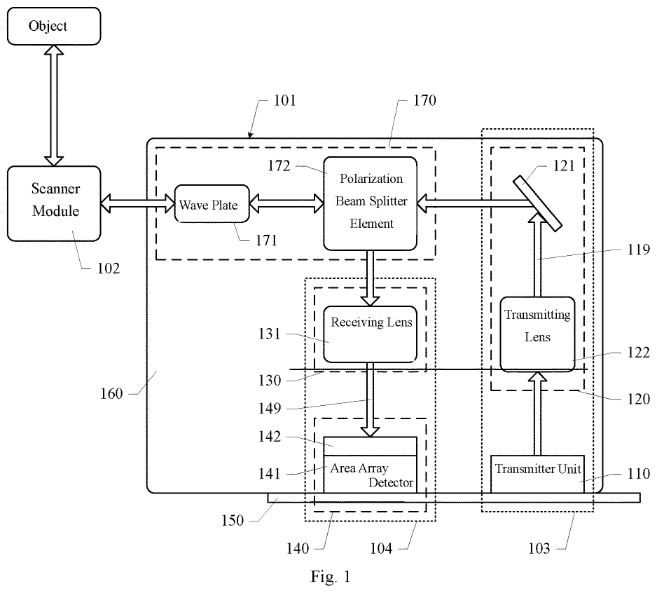

Referring to FIG. 1, FIG. 1 shows a functional block diagram of a LiDAR, provided in some embodiments of this disclosure.

The LiDAR includes an optical transceiver module 101 and a scanner module 102. The optical transceiver module 101 includes: a transmitter unit 110, where the transmitter unit 110 is configured to emit detection light 119; a transmitting lens unit 120, where the transmitting lens unit 120 is configured to transmit the detection light 119; a receiving lens unit 130, where the receiving lens unit 130 is separated from the transmitting lens unit 120, and the receiving lens unit 130 is configured to transmit echo light 149 generated by reflection of the detection light 119 from an object; and a receiver unit 140, where the receiver unit 140 includes: a two-dimensional array detector 141, where the two-dimensional array detector 141 is configured to detect the echo light 149 passing through the receiving lens unit 130. The scanner module 102 is configured to receive the detection light 119 and emit the detection light 119 towards an exterior of the LiDAR, and receive the echo light 149 and emit the echo light 149 towards the optical transceiver module 101.

In the receiver unit, using the two-dimensional array detector 141 to receive the echo light 149 is conducive to effectively reducing the receiving field of view corresponding to a detector in the LiDAR, improving the optical resolution of the optical system of the LiDAR, and improving the target resolution capability of the LiDAR. With respect to the two-dimensional array detector 141, in the optical transceiver module 101, the separated transmitting lens unit 120 and receiving lens unit 130 are used to transmit the detection light 119 and the echo light 149, respectively, different lens units are used to transmit the detection light 119 and the echo light 149, respectively, and the detection light 119 and the echo light 149 are not transmitted through the same lens unit, which is conducive to reducing aberrations of the transmitting lens unit 120 and the receiving lens unit 130, facilitating the mass production, further effectively reducing the area requirements on the two-dimensional array detector 141, and lowering the costs.

Specific technical solutions of embodiments of the LiDAR are described in detail below with reference to the accompanying drawings.

The optical transceiver module 101 is configured to emit and receive an optical signal.

The transmitter unit 110 is configured to emit the detection light 119.

In some embodiments, the transmitter unit 110 includes multiple light sources 111, and each of the light sources 111 emits a beam of the detection light 119. Among them, a light source can be a laser. For example, the laser can be a vertical-cavity surface-emitting laser (“VCSEL”). In some embodiments, the laser can also be an edge-emitting laser (“EEL”), or the like, or other light-emitting components that generate laser light. The laser light emitted by the laser may have a wavelength of any one of 905 nm, 940 nm, and 1550 nm, and may also emit laser light of other wavelengths.

In some embodiments of this disclosure, the multiple light sources 111 of the transmitter unit 110 are VCSELs. In some embodiments of this disclosure, the detection light 119 emitted by the VCSEL is polarized light, such as P-polarized light.

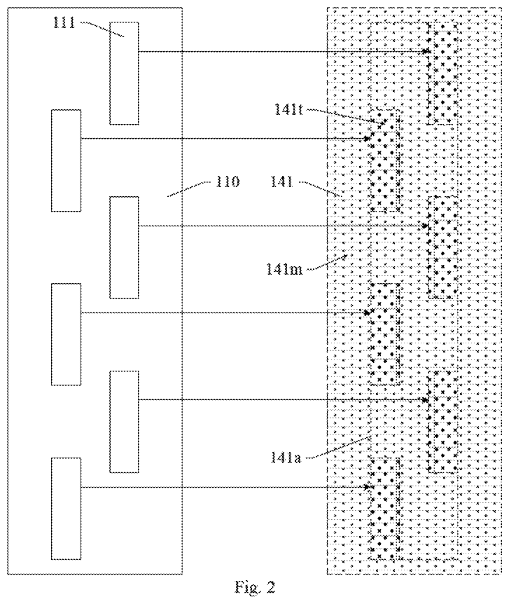

As shown in FIG. 2, the multiple light sources 111 of the transmitter unit 110 are arranged in an array, and light sources 111 in adjacent columns are provided in a staggered manner along a column direction. In some other embodiments, light sources 111 in adjacent rows are provided in a staggered manner along a row direction.

In some embodiments, FIG. 2 shows two columns of the light sources 111 in the transmitter unit 110. However, in other embodiments of this disclosure, the transmitter unit 110 can also include other number of columns of light sources, such as 3 columns or 4 columns. This disclosure does not limit the number of columns of the multiple light sources arranged in an array in the transmitter unit.

In some embodiments of this disclosure, in the multiple light sources 111 arranged in an array, the column direction corresponds to a vertical field direction of the LiDAR, and the column direction corresponds to a direction perpendicular to a horizontal plane. The row direction corresponds to a horizontal field direction of the LiDAR, and the row direction corresponds to a direction parallel to the horizontal plane.

The transmitting lens unit 120 transmits the detection light 119 to collimate and adjust an optical path.

In some embodiments shown in FIG. 1, the transmitting lens unit 120 includes a reflector 121 and a transmitting lens 122. The transmitting lens 122 includes at least one transmitting lens element, and the reflector 121 of the transmitting lens unit 120 is configured to reflect the detection light 119 to the scanner module 102.

The reflector 121 is configured to redirect the optical path of the detection light 119, and the transmitting lens 122 is configured to collimate the detection light 119. For example, the transmitting lens 122 includes multiple transmitting lens elements, the transmitting lens element is a spherical lens or an aspherical lens, and optical axes of the multiple transmitting lens elements coincide. In some embodiments shown in FIG. 1, the number of the transmitting lens elements in the transmitting lens 122 ranges from 2 to 6. As shown in FIG. 2, the reflector 121 is provided in an optical path between two transmitting lens elements in the multiple transmitting lens elements.

In some embodiments, the optical transceiver module 101 further includes a support member 160, where at least the transmitting lens unit 120 is fixed to the support member 160.

The support member 160 serves to carry and locate optical elements. The support member 160 is merely a mechanical member. Using a single mechanical member to carry the optical elements facilitates the mass production.

In some embodiments shown in FIG. 1, the transmitting lens unit 120 is fixed to the support member 160. All transmitting lens elements in the transmitting lens 122 and the reflector 121 are fixedly connected to the support member 160.

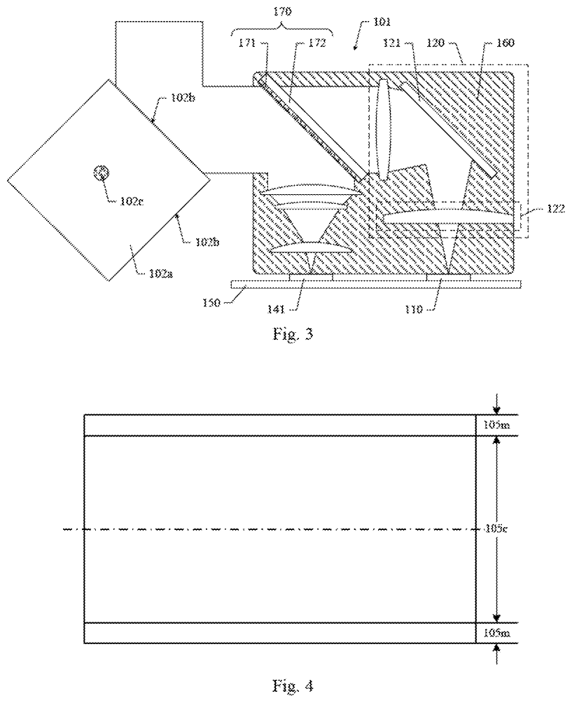

In some embodiments shown in FIG. 1 and FIG. 3, the optical transceiver module 101 further includes a beam splitter unit 170, where the beam splitter unit 170 is configured to transmit the detection light 119 transmitted by the transmitting lens unit 120 to the scanner module 102, and the beam splitter unit 170 is further configured to transmit the echo light 149 transmitted by the scanner module 102 to the receiving lens unit 130.

The beam splitter unit 170 is configured to separate the optical path of the detection light 119 from an optical path of the echo light 149. In some embodiments, the beam splitter unit 170 includes a polarization beam splitter element 172 and a wave plate 171, where the wave plate 171 is located in an optical path between the polarization beam splitter element 172 and the scanner module 102. For example, the polarization beam splitter element 172 can be a polarizing beam splitter, and the wave plate 171 can be a ¼ wave plate. Using a polarization principle for beam splitting is conducive to acquiring higher transmission efficiency under volume constraints of the LiDAR, and to ensuring a long-range detection capability of the LiDAR. Moreover, the polarization beam splitter element 172 is the polarizing beam splitter. Compared with a polarization beam splitter element of a prism structure, costs of a polarization beam splitter element with a flat plate structure are low, which is conducive to further controlling the costs.

As shown in FIG. 3, in some embodiments, the wave plate 171 is attached to a surface of the polarization beam splitter element 172 facing the scanner module 102. The wave plate 171 is directly attached to the surface of the polarization beam splitter element 172, which is conducive to effectively reducing the number of separating components in the LiDAR. The wave plate 171 is directly attached to the surface of the polarization beam splitter element 172, and neither the wave plate 171 nor a bonded surface between the wave plate 171 and the polarization beam splitter element 172 needs an anti-reflection coating, which is conducive to effectively reducing coating costs. Moreover, the wave plate 171 and the polarization beam splitter element 172 are fixedly connected, which is conducive to reducing the number of positioning surfaces, thereby lowering mechanical design complexity and costs. In addition, the wave plate 171 and the polarization beam splitter element 172 are fixedly connected, which is also conducive to reducing the number of assembly elements and lowering the production costs.

In some embodiments, the detection light incident on the polarization beam splitter element 172 is linearly polarized light, such as P-polarized light. Specifically, the linearly polarized light can be directly emitted by the VCSEL, or the linearly polarized light can be formed using a polarizer. The polarization beam splitter element 172 enables the incident linearly polarized light to be converted into circularly polarized light for emission, and after the detection light 119 in a circularly polarized state transmits the wave plate 171, it emits from the beam splitter unit 170.

In addition, in some embodiments shown in FIG. 1, the transmitting lens unit 120 is fixed to the support member 160. The beam splitter unit 170 is also fixed to the support member 160. The transmitting lens unit 120 and the beam splitter unit 170 are both fixed to the support member 160. All transmitting lens elements in the transmitting lens 122 and the reflector 121, and the polarization beam splitter element 172 and the wave plate 172 in the beam splitter unit 170 are fixedly connected to the support member 160.

Continuously referring to FIG. 1, the scanner module 102 is configured to change an emission direction of the detection light 119 to form a scanning field. The scanner module 102 reflects the detection light 119 to an exterior of the LiDAR, and the scanner module 102 reflects the echo light 149 to the optical transceiver module 101.

In some embodiments shown in FIG. 1, the scanner module 102 is a one-dimensional scanner module. Specifically, as shown in FIG. 3, the scanner module 102 includes a single-axis rotating mirror (hereinafter referred to as a rotating mirror). In some other embodiments of this disclosure, the scanner module 102 further includes a galvanometer scanner, and the galvanometer scanner includes a MEMS mirror or a Galvo mirror.

In some embodiments of this disclosure, the scanner module 102 includes a polygonal mirror 102a, where the polygonal mirror 102a includes multiple reflecting surfaces 102b, the multiple reflecting surfaces 102b rotate around a rotating shaft 102c. Angles between different reflecting surfaces 102b and the rotating shaft 102c are partially the same. An angle between at least one reflecting surface 102b and the rotating shaft 102c is different from an angle between other reflecting surfaces 102b and the rotating shaft 102c.

As shown in FIG. 3, the polygonal mirror 102a is a four-facet mirror, and the polygonal mirror 102a has four reflecting surfaces 102b. Angles between the four reflecting surfaces 102b and the rotating shaft 102c are partially the same. Among the four reflecting surfaces 102b, an angle between at least one reflecting surface 102b and the rotating shaft 102c is different from an angle between other reflecting surfaces 102b and the rotating shaft 102c.

In some embodiments of this disclosure, the polygonal mirror has an even number of reflecting surfaces, where angles between adjacent reflecting surfaces and the rotating shaft are different, while angles between spaced-apart reflecting surfaces and the rotating shaft are the same. As shown in FIG. 3, in the polygonal mirror 102a (four-facet mirror) of the scanner module 102, angles between the four reflecting surfaces 102b and the rotating shaft 102c are +1°, −1°, +1°, and −1° in sequence.

In some embodiments, positive and negative values of the angles between the reflecting surfaces 102b and the rotating shaft 102c represent that angular directions formed between the reflecting surfaces 102b and the rotating shaft 102c are different. The reflecting surfaces 102b, each having an angle of +1° with the rotating shaft 102c, share a same angular direction. An angular direction formed between the reflecting surface 102b having an angle of +1° with the rotating shaft 102c is opposite to an angular direction formed between the reflecting surface 102b having an angle of −1° with the rotating shaft 102c.

In some embodiments shown in FIG. 3, the scanner module 102 is configured to achieve scanning of the detection light 119 in a horizontal direction so as to form the horizontal field of the LiDAR. The rotating shaft 102c of the polygonal mirror 102a intersects the horizontal plane, for example, is perpendicular thereto, and a vertical field range of the detection light 119 transmitted by the beam splitter unit 170 is from −11° to +11°. A vertical field range formed by the detection light 119 reflected and emitted by the scanner module 102 is from −13° to +13°.

As shown in FIG. 4, a vertical field of view (a vertical field of view of the LiDAR) formed by the emitted detection light 119 includes: a central region 105c and edge regions 105m located on two sides of the central region 105c, where a vertical field of view range corresponding to the central region 105c is from −9° to +13°, and vertical field of view ranges of the edge regions 105m are from −13° to +13° and +9° to +13°, respectively. The detection light 119 reflected by the reflecting surfaces 102b cover the central region 105c whereas the detection light 119 reflected by adjacent reflecting surfaces 102b covers different edge regions 105m. For example, the detection light 119 reflected by one reflecting surface 102b covers an edge region 105m on an upper side, and the detection light 119 reflected by adjacent reflecting surface 102b covers an edge region 105m on a lower side. The central region 105c has a relatively high frame rate, the edge regions 105c have a relatively low frame rate, the central region 105c is a high frame rate region, and the edge regions 105c are low frame rate regions.

Through a design of the angles between different reflecting surfaces 102b in the polygonal mirror 102a and the rotating shaft 102c in the scanner module 102, adjustment of different field directions is achieved, which expands a field range without increasing design difficulty in a lens and increasing an aperture of the lens, such that costs are lowered. This is also conducive to lowering a height of the LiDAR.

As shown in FIG. 1 and FIG. 3, the scanner module 102 is located in an optical path between the beam splitter unit 170 and external space of the LiDAR. The scanner module 102 receives the detection light 119 transmitted by the beam splitter unit 170 and reflects the received detection light 119 to the external space of the LiDAR. The scanner module 102 further receives the echo light 149 generated by the reflection of the detection light 119 from the object in the external space, and reflects the received echo light 149 to the beam splitter unit 170. The beam splitter unit 170 further transmits the echo light 149 to the receiving lens unit 130.

The detection light 119, which is transmitted through the beam splitter unit 170 and is circularly polarized, is reflected by the scanner module 102 to the exterior of the LiDAR, and then reflected by the object to form the echo light 149. Without considering a depolarization influence during an external transmission process of the LiDAR, a polarization state of the echo light 149 is substantially the same as a polarization state of the detection light 119, and the echo light 149 is also the circularly polarized light.

The scanner module 102 reflects the received echo light 149 to the beam splitter unit 170. The echo light 149 incident on the beam splitter unit 170 is transmitted through the wave plate 171 and then incident on the polarization beam splitter element 172.

During a process of light beam transmission, the detection light 119, after being emitted from the polarization beam splitter element 172, is transmitted to the scanner module 102 through the wave plate 171. The echo light 149 is also transmitted through the wave plate 171 before being incident on the polarization beam splitter element 172, and after being reflected by the polarization beam splitter element 172, the echo light 149 is transmitted through the wave plate 171 again. The echo light 149 is transmitted through the wave plate 171 twice. Since the wave plate 171 is a quarter wave plate, compared with the detection light 119 emitted from the polarization beam splitter element 172 and the echo light 149 incident on the beam splitter unit 170, a phase of the echo light 149 emitted from the beam splitter unit 170 is changed by π/2, and the echo light 149 remains as the circularly polarized light. The polarization beam splitter element 172 transmits the incident echo light 149 to the receiving lens unit 130, thereby achieving separation between the optical path of the detection light 119 and the optical path of the echo light 149.

The receiving lens unit 130 is separated from the transmitting lens unit 120, the receiving lens unit 130 is located downstream of the beam splitter unit 170 in the optical path of the echo light 149, and the receiving lens unit 130 is configured to converge the echo light 149 onto the receiver unit 140.

In some embodiments, the receiving lens unit 130 includes a receiving lens 131, where the receiving lens 131 includes at least one receiving lens element. In some embodiments shown in FIG. 1 and FIG. 3, the optical path in the receiving lens unit 130 does not change; for example, the receiving lens unit 130 does not include the reflector.

The receiving lens 131 converges the echo light 149 transmitted by the beam splitter unit 170 onto the receiver unit 140. For example, the receiving lens 131 includes multiple receiving lens elements, the receiving lens element is a spherical lens or an aspherical lens, and optical axes of the multiple receiving lens elements coincide. In some embodiments shown in FIG. 1, the number of the receiving lens elements in the receiving lens 131 is in a range from 2 to 6.

In some embodiments of this disclosure, the focal length of the receiving lens 131 is not greater than the focal length of the transmitting lens 122 of the transmitting lens unit 120. In some embodiments, the focal length of the receiving lens 131 is less than the focal length of the transmitting lens 122 of the transmitting lens unit 120.

The transmitting lens 122 has a larger focal length and is adapted to the transmitter unit 110 with a larger light-emitting area. The receiving lens 131 has a smaller focal length and is adapted to the two-dimensional array detector 141 in the receiver unit 140 with a smaller photosensitive area. The transmitting lens 122 with a larger focal length and the receiving lens 131 with a smaller focal length are more suitable for the transmitter unit 110 with a large light-emitting area and the receiver unit 140 with a small photosensitive area, which is conducive to achieving a match between a transmission field and a reception field while ensuring the long-range detection capability of the LiDAR.

In some embodiments, the optical transceiver module 101 includes a transmitting assembly 103 and a receiving assembly 104, where the transmitting assembly 103 includes the transmitter unit 110 and the transmitting lens unit 120, and the receiving assembly 104 includes the receiving lens unit 130 and the receiver unit 140. As shown in FIG. 1 and FIG. 3, the receiving assembly 104 is located between the transmitting assembly 103 and the scanner module 102. The receiving assembly 104, provided between the transmitting assembly 103 and the scanner module 102, is adapted to the transmitting lens 122 with a larger focal length and the receiving lens 131 with a smaller focal length, and the optical path is provided more reasonably.

In some embodiments of this disclosure, a receiving aperture of the receiving lens 131 is greater than 8 mm. The larger the receiving aperture of the receiving lens 131, the stronger the long-range detection capability of the LiDAR. The receiving aperture of the receiving lens 131 is sufficiently large to receive enough long-range detection capability.

In some embodiments of this disclosure, a F-number of the receiving lens 131 is less than 4. The F-number of a lens, for example, an aperture ratio of the lens, is a ratio of a focal length of the lens to a diameter of an entrance pupil thereof. Luminous flux of the lens is inversely proportional to a square of the F-number. The smaller the F-number, the greater the luminous flux. The smaller the F-number of the receiving lens 131, the larger the receiving aperture of the receiving lens 131, and the higher the receiving efficiency of the echo light 149. In some embodiments, the F-number of the receiving lens 131 is less than 1.8.

In some embodiments of this disclosure, the focal length of the receiving lens 131 is determined based on spacing between adjacent pixels in the two-dimensional array detector 141 and an angular resolution of the LiDAR. For example, the spacing between the adjacent pixels in the two-dimensional detector 141 is Δd, the angular resolution of the LiDAR is Δθ, and the focal length of the receiving lens 131 is

$$f = \frac{Δ d}{Δ θ} .$$

In some embodiments of this disclosure, the optical transceiver module 101 further includes the support member 160. The receiving lens unit 130, the transmitting lens unit 120, and the beam splitter unit 170 are fixed to the support member 160. The optical elements of the LiDAR do not need adjustment, which is conducive to reducing the difficulty in adjusting the LiDAR.

Continuously referring to FIGS. 1 and 3, the receiver unit 140 includes the two-dimensional array detector 141, where the two-dimensional array detector 141 is located in the optical path of the echo light 149 downstream of the receiving lens unit 130, and the two-dimensional array detector 141 detects the echo light 149 passing through the receiving lens unit 130.

For example, the two-dimensional array detector 141 includes multiple detection elements arranged two-dimensionally, a detection element can be a single-photon detection element, and the single-photon detection element is a single-photon avalanche diode (“SPAD”).

In some embodiments, different from multiple independently encapsulated detectors arranged two-dimensionally, the multiple detection elements in the two-dimensional array detector 141 can be driven in an addressable manner, such that a distance between adjacent detection elements is smaller.

In some other embodiments, the multiple detection elements of the two-dimensional array detector 141 are arranged along two intersecting directions, where one of the directions corresponds to the vertical field direction of the LiDAR, and corresponds to the direction perpendicular to the horizontal plane; and the other direction corresponds to the horizontal field direction of the LiDAR, and corresponds to the direction parallel to the horizontal plane.

In some embodiments of this disclosure, the two-dimensional array detector 141 includes multiple pixels, and each of the pixels includes the multiple detection elements. In some embodiments, the detection element is the single-photon detection element. Each of the pixels of the two-dimensional array detector 141 includes the multiple detection elements. For example, each of the pixels includes 4 SPADs, and each of the pixels (e.g., 4 SPADs) outputs one signal for subsequent circuit sampling and processing.

In some embodiments of this disclosure, a size of a pixel in the two-dimensional array detector 141 is greater than an optical parameter of the receiving lens 131. In some embodiments, the optical parameter is an imaging quality design parameter. For example, the optical parameter is a root mean square spot radius (“RMS radius”), which refers to a spot radius received by taking a square root after performing a quadratic average of light intensity distribution. It is an index used to describe a size of the light beam.

The RMS radius of the lens can affect an optical resolution of a point cloud received by a detector. A smaller RMS radius represents better optical performance, which is conducive to receiving a clearer point cloud and a higher resolution. The size of the pixel is a key parameter of the two-dimensional array detector, and a smaller pixel allows more details to be captured.

However, receiving more detailed point clouds requires not only a smaller size of the pixel of the detector but also better lens performance. If the size of the pixel is much smaller than the RMS radius of the lens, potential resolution will be wasted.

Therefore, optimal point cloud quality is achieved through a mutual cooperation of appropriate lens optical parameters and a suitable size of the pixel. When the RMS spot radius of the lens is less than or equal to a range of the size of the pixel, it is conducive to better improving the resolution of the point cloud.

In some embodiments, each of the pixels of the two-dimensional array detector 141 includes the multiple detection elements. For example, each of the pixels includes 2×2 or 3×3 SPADs. The size of each of the pixels of the two-dimensional array detector 141 is greater than the RMS radius of the receiving lens 131.

In some embodiments shown in FIG. 2, the receiver unit 140 includes one two-dimensional array detector 141. The two-dimensional array detector 141 includes: multiple detection regions 141t, where the multiple detection regions 141t are in one-to-one correspondence with the multiple lasers 111 of the transmitter unit 110.

The receiver unit 140 uses an addressable manner of the two-dimensional array detector. Each laser of the transmitter unit 110 corresponds to one detection region 141t of the two-dimensional array detector 141 in the receiver unit 140. Each of the detection regions 141t includes at least one pixel. For example, each of the detection regions 141t includes m×n pixels, where each of the pixels generates p cloud points. In the cloud points of the LiDAR, the number of points in the vertical field is n×p, which is conducive to achieving densification of the vertical field, thereby improving a density and the resolution of the point cloud.

In some embodiments, a relationship between a light-emitting area Sₜₓ of the laser, a focal length fₜₓ of the transmitting lens 122, and a field range θₜₓ of the transmission field is as follows: fₜₓ×θₜₓ=Sₜₓ. A relationship between a photosensitive area Sᵣₓ of the detection region 141 corresponding to the laser, a focal length fᵣₓ of the receiving lens 131, and a field range θᵣₓ of the reception field is as follows: fᵣₓ×θᵣₓ=Sᵣₓ.

When an optical power density of the laser in the transmitter unit 110 is limited, the laser with a larger light-emitting area is conducive to improving the long-range detection capability of the LiDAR. However, the focal length fₜₓ of the transmitting lens 122 is greater than the focal length fᵣₓ of the receiving lens 131, which is conducive, while matching the transmission field and the reception field, to making the photosensitive area of the detection region 141t corresponding to the laser smaller, thereby helping to improve the optical resolution of the LiDAR.

Continuously referring to FIG. 2, in some embodiments, the two-dimensional array detector 141 further includes: a compensation region 141m, where the compensation region 141m encircles the multiple detection regions 141t. The two-dimensional array detector 141 can be driven in an addressable manner. The two-dimensional array detector 141 achieves alignment of the transmission field and the reception field through addressable driving, and compensates for alignment errors between the transmission field and the reception field using the compensation region 141m, thereby reducing the difficulty in optical alignment and adjustment, and even avoiding an optical alignment and adjustment process. This is conducive to adjustment-free alignment of the laser and the detector integrated on the common board.

In some embodiments of this disclosure, the optical transceiver module 101 further includes: a circuit board 150, where the laser 111 of the transmitter unit 110 and the two-dimensional array detector 141 of the receiver unit 140 are fixed to the circuit board 150. In some embodiments shown in FIG. 1, the laser 110 of the transmitter unit 111 and the two-dimensional array detector 141 of the receiver unit 140 are provided on the same circuit board 150. The laser of the transmitter unit and the two-dimensional array detector of the receiver unit are integrated on the common board, which is conducive to the mass production.

The focal length fₜₓ of the transmitting lens 122 is greater than the focal length fᵣₓ of the receiving lens 131, and a difference between the focal length fₜₓ of the transmitting lens 122 and the focal length fᵣₓ of the receiving lens 131 is appropriate, such that the laser of the transmitter unit 110 and the two-dimensional array detector 141 of the receiver unit 140 are integrated on the common board.

In some embodiments, for example, some embodiments shown in FIG. 1, the receiver unit 140 further includes: an optical filter 142, where the optical filter 142 is located in an optical path between the receiving lens 131 and the two-dimensional array detector 141. The optical filter 142 is configured to filter out stray light.

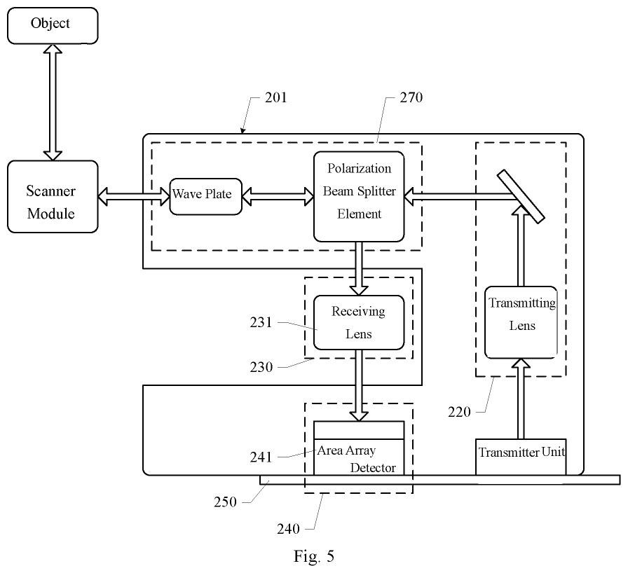

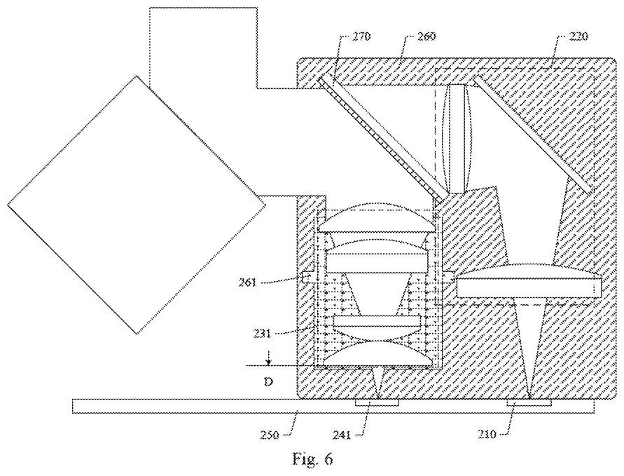

Referring to FIG. 5 and FIG. 6, FIG. 5 shows a functional block diagram of a LiDAR, provided in some other embodiments of this disclosure, and FIG. 6 shows a schematic structural diagram of the LiDAR shown in FIG. 5.

Similarities with the previous embodiments are not repeated herein in this disclosure. A difference from the previous embodiments is that, in some embodiments shown in FIG. 5 and FIG. 6, the transmitting lens unit 220 and the beam splitter unit 270 are both fixed to the support member 260. The optical transceiver module 201 further includes: a receiving lens support member 261, where the receiving lens 231 is fixed to the receiving lens support member 261, and the receiving lens support member 261 is movably connected to the support member 260.

Specifically, as shown in FIG. 6, the multiple receiving lens elements of the receiving lens 231 in the receiving lens unit 230 are all fixedly connected to the receiving lens support member 261, and the receiving lens support member 261 is movably connected to the support member 260. The receiving lens support member 261 can be adjusted relative to the support member 260 in multiple dimensions, where the dimensions can include one of two to five dimensions. By using the movable receiving lens support member 261 and employing active alignment (“AA focusing”) technologies, a distance D between the receiving lens 231 and the two-dimensional array detector 241 of the receiver unit 140 is changed, thereby achieving back focus adjustment of the receiving lens unit 230, such that the optical resolution is improved, the image quality of the optical system of the LiDAR is enhanced, and the target resolution capability of the LiDAR is improved.

In some embodiments, the receiving lens support member 261 is fixed by at least one of welding and adhesive bonding. After the back focus adjustment of the receiving lens unit 230, the receiving lens support member 261 and the support member 260 are fixedly connected by at least one of welding and adhesive bonding.

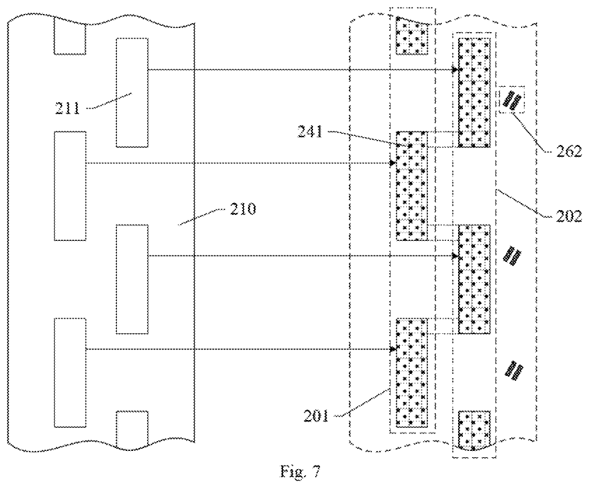

In some embodiments, as shown in FIG. 7, a circuit board 250 fixing the two-dimensional array detector 241 has multiple focusing marks 262. The focusing marks 262 are configured to perform the alignment during a process of the back focus adjustment. The focusing marks 262 have high-precision patterns. During the process of the back focus adjustment, whether different field positions of the two-dimensional array detector 241 are at an optimal back focal plane position is determined based on clarity of the patterns of the focusing marks 262. Positions of the focusing marks 262 represent pixel positions of the two-dimensional array detector 241 and are used for the alignment between the transmission field and the reception field.

For example, the focusing marks 262 are shaped as inclined double rectangles. In other embodiments of this disclosure, the focusing marks can also be circular, square, triangular, pentagonal, hexagonal, cross-shaped, target-shaped, or the like.

In some embodiments, for example, some embodiments shown in FIG. 7, the receiver unit 240 includes multiple two-dimensional array detectors 241, where the multiple two-dimensional array detectors 241 are in one-to-one correspondence with multiple lasers 211 of the transmitter unit 210. The multiple two-dimensional array detectors 241 form the receiver unit 140, which is conducive to reducing an area of a single two-dimensional array detector 241, and lowering the costs.

In some embodiments of this disclosure, the two-dimensional array detector 141 includes multiple pixels, where each of the pixels includes the multiple detection elements. In some embodiments, the detection element is the single-photon detection element, and the single-photon detection element is the single-photon avalanche diode (“SPAD”).

In some embodiments of this disclosure, the multiple two-dimensional array detectors 241 are arranged in an array, where the two-dimensional array detectors 241 in adjacent columns are provided in a staggered manner along the column direction or the two-dimensional array detectors 241 in adjacent rows are provided in a staggered manner along the row direction. As shown in FIG. 7, the multiple two-dimensional array detectors 241 are arranged in an array, and the two-dimensional array detectors 241 in adjacent columns are provided in a staggered manner along the column direction. For example, one two-dimensional array detector in a certain column is located between two two-dimensional array detectors in an adjacent column along the column direction.

For example, FIG. 7 shows four two-dimensional array detectors 241 in the receiver unit 240, arranged in a 2×2 array. A first column 201 and a second column 202 are adjacent along the row direction. The two-dimensional array detector 241 in the first column 201 is located between two adjacent two-dimensional array detectors 241 in the second column 202 along the column direction.

In some embodiments of this disclosure, adjacent two-dimensional array detectors 241 along a staggered direction have an overlapping region therebetween. For example, as shown in FIG. 7, the two-dimensional array detectors 241 in the first column 201 and the two-dimensional array detectors 241 in the adjacent second column 202 along the column direction have overlapping regions in the column direction (as indicated by dashed lines in FIG. 7): projections of the two-dimensional array detectors 241 in the first column 201 and the two-dimensional array detectors 241 in the second column 202 onto the vertical plane have overlapping regions, where the vertical plane is a plane perpendicular to a direction pointing from the first column 201 to the second column 202.

It should be noted that in some embodiments of this disclosure, the adjacent two-dimensional array detectors along the staggered direction can also be staggered completely, and there is no overlapping region between the adjacent two-dimensional array detectors along the staggered direction. For example, the two-dimensional array detectors 241 in the first column 201 and the two-dimensional array detectors 241 in the adjacent second column 202 along the column direction are staggered completely in the column direction and have no overlapping region.

The optical transceiver module includes: the transmitting lens unit, where the transmitting lens unit is configured to transmit the detection light, and collimate the detection light; and the receiving lens unit, where the receiving lens unit is separated from the transmitting lens unit, and the receiving lens unit is configured to transmit the echo light generated by the reflection of the detection light from the object. The detection light and the echo light are respectively transmitted by the separately provided transmitting lens unit and the receiving lens unit. A design of the transmitting lens unit only needs to satisfy technical requirements for collimation of the detection light, thereby improving a collimation effect of the transmitting lens unit on the detection light. A design of the receiving lens unit only needs to satisfy technical requirements for reception of the echo light, thereby enhancing a reception effect of the receiving lens unit on the echo light. Improvement of the collimation effect of the detection light and enhancement of the reception effect of the echo light are both conducive to improving detection performance of the LiDAR.

In the receiver unit, using the two-dimensional array detector to receive the echo light can effectively reduce the receiving field of view corresponding to each detector in the LiDAR, which is conducive to improving the optical resolution of the optical system of the LiDAR and improving the target resolution capability of the LiDAR. With respect to the two-dimensional array detector, in the optical transceiver module, the separated transmitting lens unit and receiving lens unit are used to transmit the detection light and the echo light, respectively, different lens units are used to transmit the detection light and the echo light, respectively, and the detection light and the echo light are not transmitted through the same lens unit, which is conducive to improving the aberrations of the transmitting lens unit and the receiving lens unit, facilitating the mass production, further effectively reducing the area requirements on the two-dimensional array detector, and lowering the costs.

Moreover, the focal length of the receiving lens is not greater than the focal length of the transmitting lens of the transmitting lens unit. The transmitting lens with the larger focal length is adapted to the laser with the larger light-emitting area, and the receiving lens with the smaller focal length is adapted to the detector with the smaller photosensitive area. The transmitting lens with the larger focal length and the receiving lens with the smaller focal length are adapted to the laser with the larger light-emitting area and the detector with the smaller photosensitive area, while the transmission field and the reception field match, which is conducive to improving the long-range detection capability of the LiDAR.

In addition, the size of the pixel in the two-dimensional array detector is greater than the optical parameter of the receiving lens. The optical parameter of the receiving lens can be a root-mean-square spot radius of the receiving lens. A relationship between the size of the pixel in the two-dimensional array detector and the optical parameter of the receiving lens will affect the point cloud quality and the optical resolution received by the two-dimensional array detector. The size of the pixel in the two-dimensional array detector matches the optical parameter of the receiving lens, which is conducive to improving the optical resolution of the LiDAR, acquiring best imaging quality, and improving the point cloud quality of the LiDAR.

In addition, the receiving aperture of the receiving lens is greater than 8 mm. The larger the receiving aperture of the receiving lens, the higher the receiving efficiency of the LiDAR for the echo light, and the stronger the long-range detection capability of the LiDAR. A sufficiently large receiving aperture of the receiving lens is conducive to improving the receiving efficiency of the echo light and enhancing the long-range detection capability of the LiDAR.

In addition, the F-number of the receiving lens is less than 4. The F-number of the lens, for example, the aperture ratio of the lens, is the ratio of the focal length of the lens to the diameter of an entrance pupil thereof. The luminous flux of the lens is inversely proportional to the square of the F-number. The smaller the F-number, the greater the luminous flux. The smaller the F-number of the receiving lens, the larger the receiving aperture of the receiving lens, and the higher the receiving efficiency of the echo light. A sufficiently small F-number of the receiving lens is conducive to improving the receiving efficiency of the echo light.

In addition, the laser of the transmitter unit and the two-dimensional array detector of the receiver unit are provided on the same circuit board. The laser of the transmitter unit and the two-dimensional array detector of the receiver unit are integrated on the common board, which is conducive to the mass production of LiDAR.

In addition, the two-dimensional array detector further includes: the compensation region, where the compensation region encircles the multiple detection regions. The two-dimensional array detector can be driven in an addressable manner. The two-dimensional array detector achieves the alignment of the transmission field and the reception field through the addressable driving, and compensates for the alignment errors between the transmission field and the reception field using the compensation region, thereby reducing the difficulty in the optical alignment and adjustment, and even avoiding the optical alignment and adjustment process. This is conducive to the adjustment-free alignment of the laser and the detector integrated on the common board.

In addition, the beam splitter unit includes: the polarization beam splitter element and a wave plate, where the wave plate is located in the optical path between the polarization beam splitter element and the scanner module. A solution that uses the polarization principle for the beam splitting is conducive to effectively improving the transmission efficiency under the volume constraints of the LiDAR, and is conducive to improving performance of the LiDAR.

In addition, the wave plate is attached to the surface of the polarization beam splitter element facing the scanner module. The wave plate is directly attached to the surface of the polarization beam splitter element, and neither the wave plate nor the bonded surface between the wave plate and the polarization beam splitter element needs the anti-reflection coating, which is conducive to effectively reducing the coating costs. Moreover, the wave plate and the polarization beam splitter element are fixedly connected, which is conducive to reducing the number of the positioning surfaces, thereby lowering the mechanical design complexity and the costs. In addition, the wave plate and the polarization beam splitter element are fixedly connected, which is also conducive to reducing the number of the assembly elements and lowering the production costs. Furthermore, the polarization beam splitter element is of the flat plate structure, and compared with the polarization beam splitter element of the prism structure, the costs are lower, which is conducive to further lowering the costs of the LiDAR.

In addition, the scanner module includes the polygonal mirror, where the polygonal mirror includes the multiple reflecting surfaces, the multiple reflecting surfaces all rotate around the rotating shaft, and the angles between different reflecting surfaces and the rotating shaft are partially the same. The angles between different reflecting surfaces and the rotating shaft are partially the same, thereby achieving the adjustment of different field directions, which expands a vertical field range of the LiDAR without increasing the design difficulty in the lens and increasing the aperture of the lens, such that the costs are lowered. Furthermore, it is further conducive to reducing a size of the circuit board provided with the laser and the two-dimensional array detector, which is conducive to effectively lowering the height of the LiDAR.

Although this disclosure is disclosed above, this disclosure is not limited thereto. Any person skilled in the art can make various changes and modifications without departing from the spirit and the scope of this disclosure. Therefore, a protection scope of this disclosure should be subject to a scope defined by claims.

1. A LiDAR, comprising:
an optical transceiver module; and
a scanner module, wherein
the optical transceiver module comprises:
a transmitter unit, wherein the transmitter unit is configured to emit detection light;
a transmitting lens unit, wherein the transmitting lens unit is configured to transmit detection light;
a receiving lens unit, wherein the receiving lens unit is separated from the transmitting lens unit, and the receiving lens unit is configured to transmit echo light generated by reflection of the detection light from an object; and
a receiver unit, wherein the receiver unit comprises a two-dimensional array detector, wherein the two-dimensional array detector is configured to detect the echo light passing through the receiving lens unit, wherein
the scanner module is configured to receive the detection light and emit the detection light towards an exterior of the LiDAR, and receive the echo light and emit the echo light towards the optical transceiver module.

2. The LiDAR of claim 1, wherein the transmitting lens unit comprises a reflector and a transmitting lens, wherein the transmitting lens comprises at least one transmitting lens element, and the reflector is configured to reflect the detection light to the scanner module.

3. The LiDAR of claim 1, wherein the receiving lens unit comprises a receiving lens, wherein the receiving lens comprises at least one receiving lens element.

4. The LiDAR of claim 3, wherein a focal length of the receiving lens is not greater than a focal length of the transmitting lens of the transmitting lens unit.

5. The LiDAR of claim 4, wherein a receiving assembly is located between a transmitting assembly and the scanner module, wherein the transmitting assembly comprises: the transmitter unit and the transmitting lens unit, and the receiving assembly comprises: the receiver unit and the receiving lens unit.

6. The LiDAR of claim 3, wherein a size of a pixel in the two-dimensional array detector is greater than an optical parameter of the receiving lens.

7. The LiDAR of claim 3, wherein a receiving aperture of the receiving lens is greater than 8 mm.

8. The LiDAR of claim 3, wherein a F-number of the receiving lens is less than 4.

9. The LiDAR of claim 1, wherein a laser of the transmitter unit and a two-dimensional array detector of the receiver unit are provided on a same circuit board.

10. The LiDAR of claim 1, wherein the optical transceiver module further comprises: a support member, wherein at least the transmitting lens unit is fixed to the support member.

11. The LiDAR of claim 10, wherein the transmitting lens unit and a beam splitter unit are both fixed to the support member.

12. The LiDAR of claim 11, wherein the optical transceiver module further comprises: a receiving lens support member, wherein the receiving lens is fixed to the receiving lens support member, and the receiving lens support member is movably connected to the support member.

13. The LiDAR of claim 12, wherein a circuit board fixing the two-dimensional array detector has a plurality of focusing marks.

14. The LiDAR of claim 11, wherein the receiving lens unit, the transmitting lens unit, and the beam splitter unit are fixed to the support member.

15. The LiDAR of claim 1, wherein the receiver unit comprises one two-dimensional array detector, wherein the two-dimensional array detector comprises: a plurality of detection regions, and the plurality of detection regions are in one-to-one correspondence with a plurality of lasers of the transmitter unit.

16. The LiDAR of claim 15, wherein the two-dimensional array detector further comprises: a compensation region, wherein the compensation region encircles the plurality of detection regions.

17. The LiDAR of claim 15, wherein the receiver unit comprises a plurality of two-dimensional array detectors, wherein the plurality of two-dimensional array detectors are in one-to-one correspondence with the plurality of lasers of the transmitter unit.

18. The LiDAR of claim 17, wherein the plurality of two-dimensional array detector are arranged in an array, and two-dimensional array detectors in adjacent columns are provided in a staggered manner along a column direction or two-dimensional array detectors in adjacent rows are provided in a staggered manner along a row direction.

19. The LiDAR of claim 1, wherein the two-dimensional array detector comprises a plurality of pixels, wherein each of the pixels comprises a plurality of detection elements.

20. The LiDAR of claim 19, wherein a detection element is a single-photon detection element.
